(19) United States
(12) Patent Application Publication
(10) Pub. No.: US 2019/0156003 A1
(43) Pub. Date: May 23, 2019

(54) Methods and Systems for Launching Additional Authenticators in an Electronic Device

(71) Applicant: Motorola Mobility LLC, Chicago, IL (US)

(72) Inventors: Rachid Alameh, Crystal Lake, IL (US); Jarrett Simerson, Glenview, IL (US); Thomas Merrell, Beach Park, IL (US)

(21) Appl. No.: 15/818,415

(22) Filed: Nov. 20, 2017

(51) Int. Cl. G06F 21/32

(52) U.S. Cl. CPC G06F 21/32

(57) ABSTRACT

An electronic device includes one or more sensors, a first authenticator, and at least a second authenticator. The first authenticator is operable to attempt to authenticate authentication input of a first type, while the second authenticator is operable to attempt to authenticate authentication input of a second type, wherein the second type is different from the first type. One or more processors launch or actuate the second authenticator where the first authenticator authenticates the authentication input of the first type and one or more sensors detect the authentication input of the second type.

### BACKGROUND

### Technical Field

This disclosure relates generally to electronic device, and more particularly to user authentication in electronic devices.

### Background Art

Portable electronic devices were, not too long ago, relatively simple devices to use. To make a telephone call on a mobile phone, one simply pushed buttons to enter a telephone number and hit a “send” key. Today, however, modern smartphones have computing power that exceeds that of most desktop computers of only a few years ago.

With all of this computing power comes increased functionality. In addition to voice, text, and multimedia communication, users employ devices such as smartphones to execute financial transactions, record, analyze, and store medical information, store pictorial records of their lives, maintain calendar, to-do, and contact lists, and even perform personal assistant functions.

Navigating the various features and systems available in modern electronic devices can be daunting. As many devices no longer include a physical keyboard, mentally understanding the various slides, taps, swipes, and other gestures required to invoke a particular application or feature takes time, can be cumbersome, and may prevent a user from even using the application or feature. It would be advantageous to have an improved electronic device with simpler access to advanced features.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory system and method in accordance with one or more embodiments of the disclosure.

FIG. 2 illustrates one explanatory system in accordance with one or more embodiments of the disclosure.

FIG. 3 illustrates examples of authenticators in accordance with one or more embodiments of the disclosure.

FIG. 4 illustrates one explanatory electronic device in accordance with one or more embodiments of the disclosure.

FIG. 5 illustrates explanatory components of one explanatory system in accordance with one or more embodiments of the disclosure.

FIG. 6 illustrates one explanatory method in accordance with one or more embodiments of the disclosure.

FIG. 7 illustrates another explanatory method in accordance with one or more embodiments of the disclosure.

FIG. 8 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to launching a second authentication system while a first authentication system is authenticating a user of an electronic device. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of launching an ancillary authentication system, to train or refine that ancillary authentication system, while a primary authentication system is in operation as described herein. The non-processor circuits may include, but are not limited to, a radio receiver, a radio transmitter, signal drivers, clock circuits, power source circuits, and user input devices. As such, these functions may be interpreted as steps of a method to perform launch of a second authentication system to configure the second authentication system for, or for better, operation.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. As used herein, components may be “operatively coupled” when information can be sent between such components, even though there may be one or more intermediate or intervening components between, or along the connection path. The terms “substantially” and “about” are used to refer to dimensions, orientations, or alignments inclusive of manufacturing tolerances. Thus, a “substantially orthogonal” angle with a manufacturing tolerance of plus or minus two degrees would include all angles between 88 and 92, inclusive. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods and systems for launching a second authenticator while a first authenticator is in operation. In one or more embodiments, one or more sensors of an electronic device receive an authentication input of a first type. The authentication input identifies an authorized user of the electronic device. The electronic device therefore attempts to authenticate, with a first authenticator, the authentication input.

Embodiments of the disclosure contemplate that it is possible to receive another input of a second type that also identifies the authorized user of the electronic device. The second type can be different from the first type. For example, the first input of the first type might be a facial depth scan, while the other input of the second type is voice input.

To enable multiple authenticators to allow access to the electronic device with minimal interaction with the authorized user, in one or more embodiments when the second input is detected, one or more processors launch a second authenticator. The second authenticator can then process the second input. This processing can include storing the second input, or representations thereof, in memory, refining predefined authentication references of the second type with the second input, or other processing.

Illustrating by example, in one embodiment the first authenticator can comprise a facial depth scanner. Accordingly, a person may look at an electronic device so that the facial depth scanner can scan the person's face. This scan can then be compared to an authentication reference stored in memory so that one or more processors can determine whether the person is an authorized user of the electronic device. If so, the device can be unlocked. If not, the device can remain locked.

Now consider the situation where the person is also talking while the facial depth scan is occurring. In one or more embodiments, one or more processors can detect reception of the person's voice as a second form of input that is different from the first input. To provide a more seamless user experience, in one or more embodiments the one or more processors can then launch a voice authenticator. If the voice authenticator has not been used before, once the facial depth scan is confirmed as that of the authorized user, a digital representation of the voice input can be stored in memory as a predefined authentication reference. In one or more embodiments, prior to storing the predefined authentication reference, the methods and systems can confirm that the voice input is coming from the user. For example, microphones can beam-steer toward the face being scanned for confirmation. Alternatively, video or photographs of the face being scanned can be captured to confirm the lips of the face are moving. In still other embodiments, facial recognition systems that can read lips, combined with speech recognition, could be used to make sure that what is recorded from the microphones is from the authorized user. Speech recognition would translate audio into text and lip reading would translate what it sees into what it thinks was said. The two outputs could then be compared. Accordingly, and advantageously, the next time the user accesses the electronic device either the facial depth scan or voice recognition can be used to authenticate the user.

In other embodiments, such as where a predefined voice authentication reference exists in memory due to the fact that the voice recognition authenticator has been used before, once the facial depth scan is confirmed as that of the authorized user, this predefined authentication reference can be further refined with the voice input to more accurately be used in authentication of the person as an authorized user. Other processing operations using the second input will be obvious to those of ordinary skill in the art having the benefit of this disclosure.

In one embodiment, when someone is speaking, a voice authenticator monitors and syncs received audible signals from an authorized user. An image authenticator may capture images of the person's face. A location authenticator can determine the location of the electronic device. Where a first authenticator, such as a facial depth scanner, authenticates the person as an authorized user of the electronic device, received audio can be tagged as belonging to the authorized user and stored in memory as a predefined audio authentication reference. This predefined authentication reference can then be used in the future as a second technique, i.e., voice recognition, to authenticate a person as an authorized user. Note that in one or more embodiments this launch of the second authenticator while a first authenticator is operational is “passive” in that the user does not interact with the electronic device to affirmatively launch the second authenticator. To the contrary, in this example, one method of authentication, e.g., the use of a facial depth scanner, can enable a second method of authentication, e.g., voice recognition, by association in the background to offer additional authentication features to a user automatically.

In one or more embodiments, authentication made by the second authenticator, which was passively launched initially, can be supplemented by the use of contextual information. For instance, in the situation where a person was at one time talking while a facial depth scan was occurring, and this caused the launch of a voice recognition authenticator, which used the received audio to create a predefined authentication model, in one or more embodiments a location authenticator determines the location of the electronic device while the audio input is being received. Going forward, in one or more embodiments when authentication by voice recognition, i.e., by the second authenticator, occurs, location can be used to provide an additional level of confirmation that the person being authenticated is in fact an authorized user.

Illustrating by example, if the voice input was initially captured in a person's home, or their car, or their office, this location can be stored when received audio is used to create a predefined authentication model. When subsequent voice recognition authentication steps occur, and the person is in the same location, i.e., in the home, car, or office, the fact that voice authentication is occurring in the same location that the initial training of the second authenticator occurred can provide additional level of confirmation that the person being authenticated is in fact an authorized user.

In one or more embodiments, contextual information can also be used to preclude the launch of the second authenticator despite the fact that second authentication input is being received when a primary authenticator is authenticating first authentication input. Said differently, in one or more embodiments methods and systems determine, with the one or more sensors, whether environmental conditions match one or more predefined criteria. The methods and systems then preclude storing any secondary input as a predefined authentication reference, or alternatively preclude refining any previously stored predefined authentication reference, unless the environmental conditions match the one or more predefined criteria.

Illustrating by example, when second authentication input is being received when a primary authenticator is authenticating first authentication input, and the second authentication input is acoustic input, one or more sensors may determine that there is too much ambient noise to properly create a predefined authentication reference. Accordingly, in such a situation systems and methods may preclude storing any secondary input as a predefined authentication reference, or alternatively preclude refining any previously stored predefined authentication reference because the ambient noise level fails to fall below a predefined ambient noise level threshold. Similarly, when second authentication input is being received when a primary authenticator is authenticating first authentication input, and the second authentication input is a facial depth scan, imagers may determine that multiple people are found within captured images. This may preclude properly scanning the authorized user. As such, systems and methods may preclude storing any secondary input as a predefined authentication reference, or alternatively preclude refining any previously stored predefined authentication reference because the number of people near the electronic device fails to fall below a predefined person quantity threshold.

The fact that second authenticators can be launched while primary authenticators are authenticating primary input offers several advantages. For instance, passively training the second authenticator with second output allows the second authenticator to be used as the primary authenticator in the future. While an electronic device may initially allow authentication only by facial depth scan, the launch and training of a voice recognition authenticator during facial authentication allows a user to unlock a device using voice in situations where they are not facing the facial scanner.

In other embodiments, the second authenticator can be layered upon the first authenticator. Embodiments of the disclosure contemplate that some applications will require a higher level of authentication than others. For instance, applications handling financial account information, health information, social security numbers, genome sequences, or other information may require higher levels of authentication than do applications for crossword puzzles, the weather, or sports scores. In one or more embodiments, a combination of two, three, four, or more authenticators. Advantageously, the passive launch and training of authenticators beyond a primary authenticator allows such higher-level authentication to occur without the user having to manually train each authenticator during device setup.

Accordingly, in one or more embodiments one form of authentication passively launches other forms of authentication, thereby enabling those other forms of authentication for future use. For instance, when a person enters a passcode, a facial recognition device may capture a Red-Green-Blue (RGB) image of the person entering the passcode, a facial depth scan of the person entering the passcode, or a combination thereof, so that facial recognition can be used for authentication in the future. If only the RGB image is initially used in facial recognition, during the next iteration this can launch a facial depth scanner to add it to the number of authenticators. Similarly, if the facial recognition is used in the next authentication, and the person is speaking, this can launch a third or fourth authenticator configured for voice authentication. Moreover, as noted above, contextual information such as location can add another level of confirmation. The contextual information can also be used to preclude passive authentication training or refining in certain conditions as noted above.

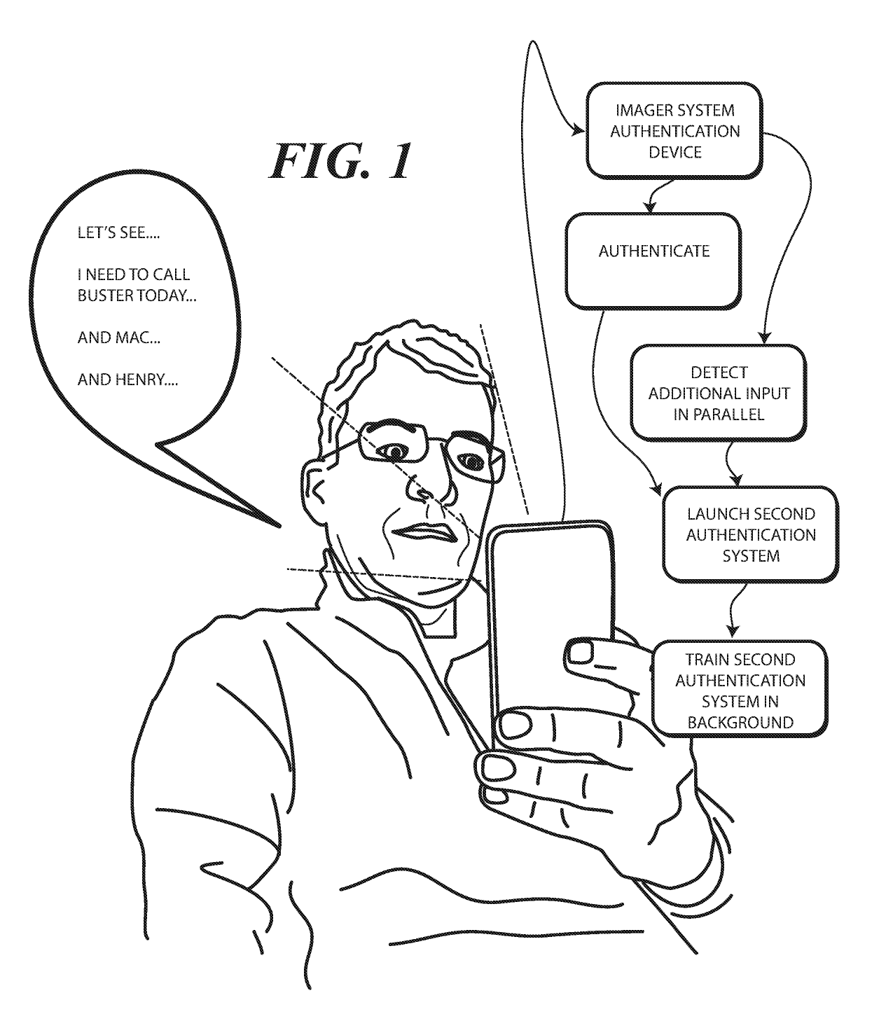

Turning now to FIG. 1, illustrated therein is one explanatory system 100 configured in accordance with one or more embodiments of the disclosure. As shown, a user 101 is authenticating himself as an authorized user of the electronic device 102 in accordance with one or more embodiments of the disclosure. In this illustrative embodiment, the user 101 is delivering an authentication input of a first type 103 that identifies the user 101 as an authorized user of the electronic device 102 to a first authenticator 104. The authentication input of the first type 103 in this embodiment is a facial recognition input. The facial recognition input can comprise two-dimensional imaging, depth scan imaging, thermal sensing, optionally one or more higher authentication factors, or combinations thereof.

In this illustrative embodiment, the first authenticator 104 is an imager. The imager captures at least one image 105 of an object situated within a predefined radius of the electronic device 102, which in this case is the user 101. In one embodiment, the imager captures a single image 105 of the object. In another embodiment, the imager captures a plurality of images of the object. In one or more embodiments, the one or more images are each a two-dimensional image. For example, in one embodiment the image 105 is a two-dimensional RGB image. In another embodiment, the image 105 is a two-dimensional infrared image. Other types of two-dimensional images will be obvious to those of ordinary skill in the art having the benefit of this disclosure.

In one or more embodiments, the image 105 can be compared to one or more predefined reference images stored in memory of the electronic device 102. By making such a comparison, one or more processors disposed within the electronic device can confirm whether the shape, skin tone, eye color, hair color, hair length, and other features identifiable in a two-dimensional image are that of the authorized user identified by the one or more predefined reference images.

In one or more embodiments, the first authenticator 104 further comprises a depth imager. In one or more embodiments the depth imager captures at least one depth scan 106 of the object when situated within the predefined radius of the electronic device 102. In one embodiment, the depth imager captures a single depth scan 106 of the object. In another embodiment, the depth imager captures a plurality of depth scans of the object.

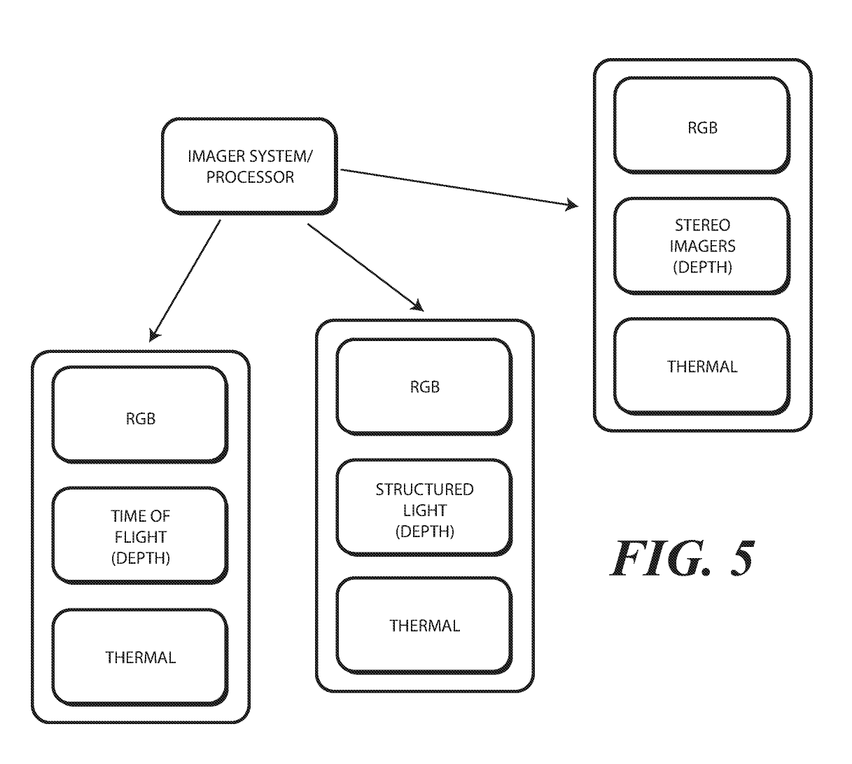

As will be described below in more detail with reference to FIG. 5, the depth imager, where included with the first authenticator 104, can take any of a number of forms. These include the use of stereo imagers, separated by a predefined distance, to create a perception of depth, the use of structured light lasers to scan patterns—visible or not—that expand with distance or project different patterns, and that can be captured and measured to determine depth or projecting different patterns, time of flight sensors that determine how long it takes for an infrared or laser pulse to translate from the electronic device 102 to the user 101 and back. Other types of depth imagers will be obvious to those of ordinary skill in the art having the benefit of this disclosure. However, in each case, the depth scan 106 creates a depth map of a three-dimensional object, such as the user's face 107. This depth map can then be compared to one or more predefined facial maps stored in memory to confirm whether the contours, nooks, crannies, curvatures, and features of the user's face 107 are that of the authorized user identified by the one or more predefined facial maps.

In one or more embodiments, the image 105 and the depth scan 106 are used in combination for authentication purposes. Illustrating my example, in one or more embodiments one or more processors compare the image 105 with the one or more predefined reference images. The one or more processors then compare the depth scan 106 with the one or more predefined facial maps.

Authentication will fail in one or more embodiments unless the image 105 sufficiently corresponds to at least one of the one or more predefined images and the depth scan 106 sufficiently corresponds to at least one of the one or more predefined facial maps. As used herein, “sufficiently” means within a predefined threshold. For example, if one of the predefined images 108 includes five hundred reference features, such as facial shape, nose shape, eye color, background image, hair color, skin color, and so forth, the image 105 will sufficiently correspond to at least one of the one or more predefined images when a certain number of features in the image 105 are also present in the predefined images. This number can be set to correspond to the level of security desired. Some users may want ninety percent of the reference features to match, while other users will be content if only eighty percent of the reference features match, and so forth.

As with the predefined images, the depth scan 106 will sufficiently match the one or more predefined facial maps when a predefined threshold of reference features in one of the facial maps is met. In contrast to two-dimensional features found in the one or more predefined images, the one or more predefined facial maps will include three-dimensional reference features, such as facial shape, nose shape, eyebrow height, lip thickness, ear size, hair length, and so forth. As before, the depth scan 106 will sufficiently correspond to at least one of the one or more predefined facial maps when a certain number of features in the depth scan 106 are also present in the predefined facial maps. This number can be set to correspond to the level of security desired. Some users may want ninety-five percent of the reference features to match, while other users will be content if only eighty-five percent of the reference features match, and so forth.

The use of both the imager 105 and the depth scan 106 as combined authentication factors is far superior to using one or the other alone. The depth scan 106 adds a third “z-dimension” to the x-dimension and y-dimension data found in the image 105, thereby enhancing the security of using the user's face 107 as their password in the process of authentication by facial recognition. Another benefit of using the depth scan 106 in conjunction with the image 105 is the prevention of someone “faking” the imager acting alone by taking an image 105 of a picture of the user 101, rather than the user 101 themselves. Illustrating by example, if only the imager is used, a nefarious person trying to get unauthorized access to the electronic device 102 may simply snap a picture of a two-dimensional photograph of the user 101. The use of a depth scan 106 in conjunction with the image 105 prevents this type of chicanery by requiring that a three-dimensional object, i.e., the actual user 101, be present and within the predefined radius before the authentication system authenticates the user 101.

The opposite is also true. Use of only the depth imager, without the imager, is similarly problematic. If only the depth imager is used, a nefarious actor attempting to gain unauthorized access to the electronic device 102 may create a three-dimensional, lifelike mask of the user 101. However, the use of the image 105 in conjunction with the depth scan 106 prevents this, as features of the user 101 that are hard to replicate with a mask are verified from the image 105, which is a RGB image in one or more embodiments. Features such as facial shape, nose shape, eye color, hair color, skin color, and so forth can be sufficiently verified by comparing the image 105 to the one or more predefined reference images. Advantageously, the use of the image in conjunction with the depth scan 106 prevents this type of chicanery by capturing a color two-dimensional image of the object, thereby confirming that the object looks like the user 101 in addition to being shaped like the user 101.

In one or more embodiments, authentication 108 occurs where each of the following is true: the at least one image 105 sufficiently corresponds to at least one of the one or more predefined images 108 and the at least one depth scan 106 sufficiently corresponds to at least one of the one or more predefined facial maps. Where both are true, in one or more embodiments, the object is authenticated 108 as the user 101 authorized to use the electronic device 102.

In one or more embodiments, when the authentication 108 fails, for whatever reason, the one or more processors can lock or limit full access the electronic device 102 to preclude access to it or the information stored therein. For example, if the at least one image 105 fails to sufficiently correspond to at least one of the one or more predefined images the one or more processors can lock the electronic device 102 to preclude access to it or reduce access or the information stored therein. Similarly, if the at least one depth scan 106 fails to correspond to at least one of the one or more predefined facial maps, the one or more processors can lock the electronic device 102 to preclude access to it or the information stored therein. When the electronic device 102 is locked, the one or more processors may then require additional authentication factors beyond the image 105 or the depth scan 106 to authenticate the user 101 at the next authentication cycle.

In this embodiment, while one or more sensors carried by the electronic device 102 are receiving the authentication input of the first type 103 and are attempting to authenticate 108 the authentication input of the first type 103 with the first authenticator 104, note that the user 101 is talking 109. In this embodiment, the user 101 is simply musing to himself what needs to be accomplished that day, e.g., call Buster, Mac, and Henry. However, in this illustrative embodiment the electronic device 102 is equipped with at least a second authenticator 110, which is an authenticator configured to process audible input to determine if its acoustic characteristics match one or more predefined voice print references stored in a memory of the electronic device.

Since this is the case, one or more processors operable with one or more sensors within the electronic device 102 detect this speech 109 as another authentication input of a second type 112. In this embodiment, the another authentication input of the second type 112, i.e., audio input, is different from the authentication input of the first type 103, which was one or more of an RGB image and facial depth scan.

Since second authentication input of the second type 112 is being received, in one or more embodiments, where the authentication input of the first type 103 authenticates 108 the user 101 as an authorized user of the electronic device 102, the one or more processors of the electronic device 102 then launch the second authenticator 110. Upon launching the second authenticator 110, in one or more embodiments the second authenticator 110 then processes 113 the other input of the second type 112.

This processing 113 can take several forms. If the second authenticator 110 has not been configured to recognize the user 101 as an authorized user of the electronic device 102, the processing 113 can comprise training the second authenticator to recognize the other authentication input of the second type as identifying the user 101 as an authorized user of the electronic device 102. Accordingly, in such an embodiment the processing 113 can include storing, with the second authenticator 110, one or more digital representations of the another input of the another authentication input of the second type 112 as a predefined authentication reference in a memory, against which future authentication input of the second type can be compared to authenticate 108 the user 101 as an authorized user of the electronic device 102.

By contrast, where the second authenticator 110 has been trained previously, the processing 113 can comprise refining any predefined authentication references to make for a more precise authentication of the user 101 as an authorized user of the electronic device 102. For example, if the user happens to be in a quiet environment in which the another input of the second type is of particularly good quality, and the predefined authentication reference of the second type stored in memory was captured in a louder environment, more discernable nuances of the user's voice may be incorporated into the predefined authentication reference to make it a more accurate authenticator. Accordingly, in one or more embodiments the processing 113 comprises revising, with the second authenticator, the predefined authentication reference with the other authentication input of the second type 112.

Advantageously, the method steps shown in FIG. 1 allow for the “passive” launch and training of at least one additional authenticator. This launch and training is “passive” because the user 101 had to take no affirmative steps or make any manual operations to cause the launch and training to occur. To the contrary, it occurred automatically due to the fact that the other authentication input of the second type happened to be detected by one or more sensors while the user 101 was being authenticated by the first authenticator.

In one or more embodiments, during future authentications the user 101 can deliver either the authentication input of the first type 103 or the other authentication input of the second type 112 to the electronic device 102 for authentication. Thus, the user 101 could authenticate themself using either facial recognition or voice recognition. In other embodiments, where higher levels of authentication are required, such as to access financial or health applications, both the authentication input of the first type 103 and the other authentication input of the second type 112 to the electronic device 102 for authentication.

In this illustrative embodiment, the user 101 happens to be sitting in a chair at home 114. Thus, in this illustration the processing 113 occurs in the home 114. Future attempts at authentication 108 using the second authenticator 110 can be supplemented by the use of contextual information. Here, since launch of a voice recognition authenticator, which used the another authentication input of the second type 112 to create a predefined authentication model, occurred at home 114, a location authenticator in the electronic device 102 can determine this location of the electronic device 102 while the another authentication input of the second type 112 is being received. Going forward, in one or more embodiments when authentication by voice recognition, i.e., by the second authenticator 110, occurs, determination of whether the electronic device 102 is in the home 114, i.e., at the same location, can be used to provide an additional level of confirmation that the user 101 being authenticated is in fact an authorized user.

In this example, the voice input is initially captured in home 114 of the user 101. This location can be stored when the other authentication input of the second type 112 is used to create a predefined authentication model. When subsequent voice recognition authentication steps occur, and the person is in the same location, i.e., in the home 114, the fact that voice authentication is occurring in the same location that the initial training of the second authenticator 110 occurred can provide additional level of confirmation that the user 101 is in fact an authorized user.

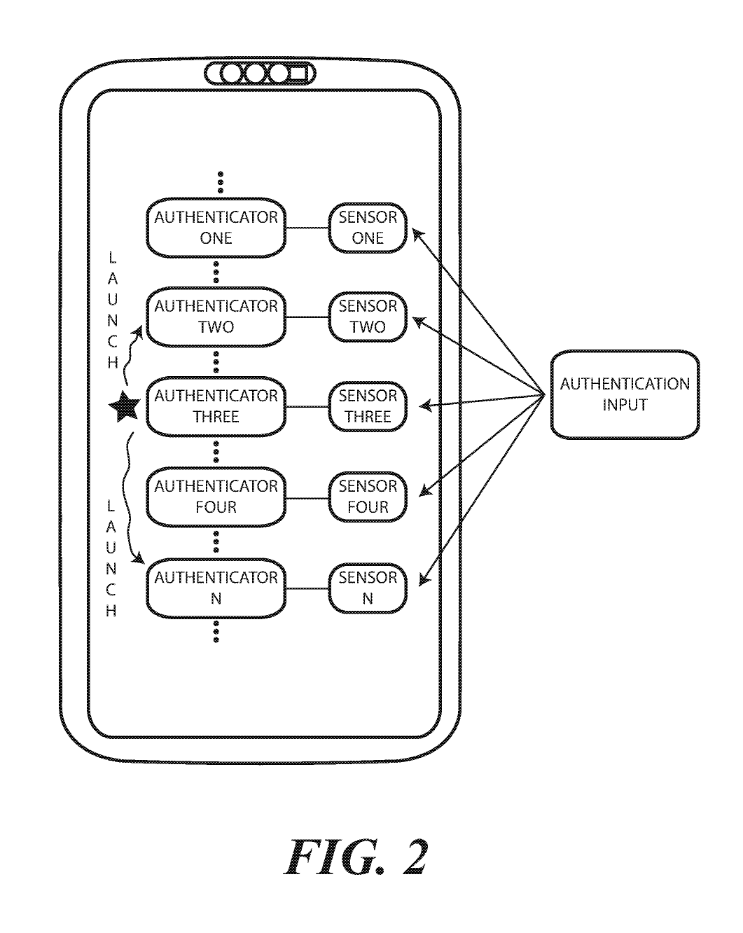

Turning now to FIG. 2, illustrated therein is one explanatory electronic device 102 configured in accordance with one or more embodiments of the disclosure. In this illustrative embodiment, the electronic device 102 includes several different sensors 201,202,203,204,205. Additionally, the electronic device 102 includes several different authenticators 206,207,208,209,210. In this illustration, each of the authenticators 206,207,208,209,210 corresponds to its respective sensor 201,202,203,204,205 on a one-to-one basis. However, in other embodiments one or more of the authenticators 206,207,208,209,210 can share one or more of the sensors 201,202,203,204,205. One or more processors 211 are operable with the authenticators 206,207,208,209,210, and optionally the one or more sensors 201,202,203,204,205, in one or more embodiments.

Here a first authenticator 206 is operable with a first sensor 201 to authenticate authentication input 212 when it is of a first type 214. Similarly, a second authenticator 207 is operable with a second sensor 202 to authenticate the authentication input 212 when it is of a second type 215. A third authenticator 208 can be configured to authenticate the authentication input 212 when it is of a third type, while a fourth authenticator 209 can be configured to authenticate the authentication input 212 when it is of a fourth type, and so forth. While five authenticators 206,207,208,209,210 are shown for illustration in FIG. 2, there could be more or fewer authenticators in other embodiments.

In one or more embodiments, the authentication input suitable for each authenticator 206,207,208,209,210 is different. Thus, an authentication input of a first type would be different from an authentication input of a second type, which would be different form an authentication input of a third type, and so forth.

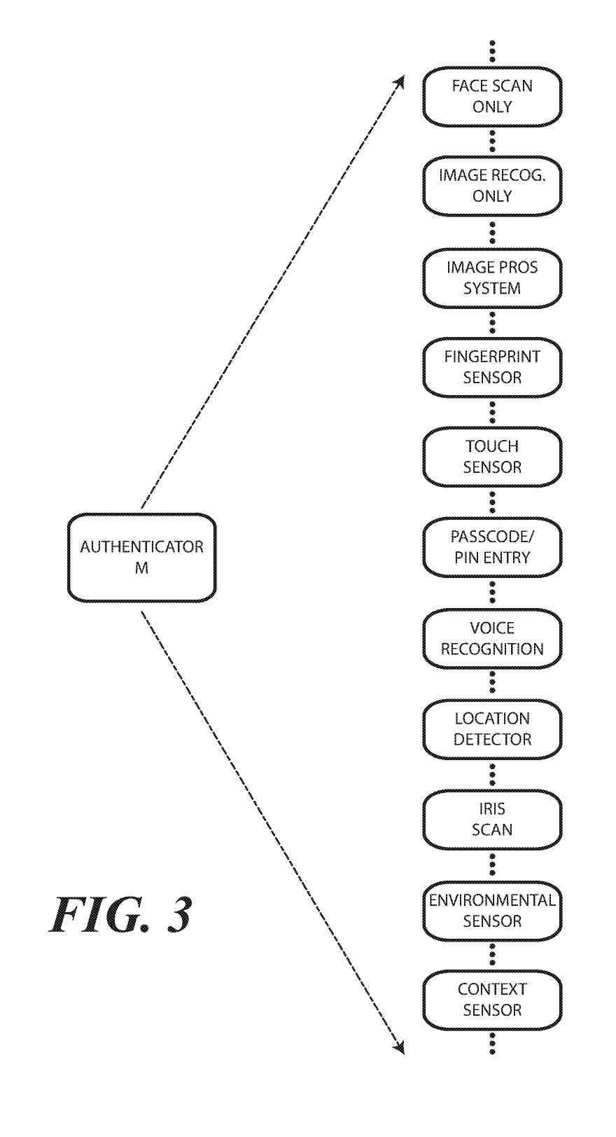

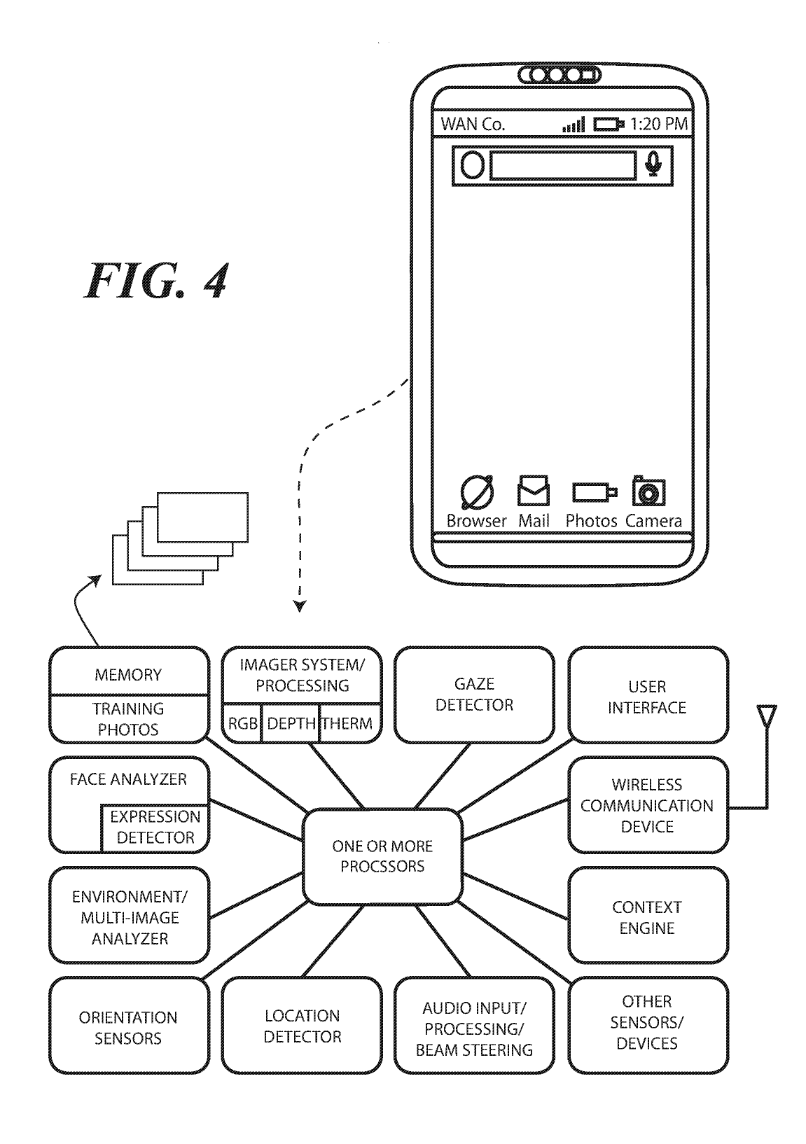

Turning briefly to FIG. 3, illustrated therein are various examples of authenticators that can be used with electronic devices in accordance with one or more embodiments of the disclosure. The authenticators can be used in alone or in combination. Moreover, the authenticators are illustrative only, and are not intended to provide a comprehensive list of authenticators. Numerous other authenticators will be obvious to those of ordinary skill in the art having the benefit of this disclosure. Additional examples of how the various authenticators can be used will be described below with reference to FIGS. 4, 6, and 7.

A first authenticator 301 can comprise a facial scanner. The first authenticator 301 can capture at least one depth scan an object when situated within the predefined radius of an electronic device (102). In one embodiment, facial scanner captures a single depth scan of the object. In another embodiment, the facial scanner captures a plurality of depth scans of the object.

The facial scanner can take any of a number of forms. These include the use of stereo imagers, separated by a predefined distance, to create a perception of depth, the use of structured light lasers to scan patterns—visible or not—that expand with distance and that can be captured and measured to determine depth or projecting different patterns, time of flight sensors that determine how long it takes for an infrared or laser pulse to translate from an electronic device to a user and back. Other types of facial scanners will be obvious to those of ordinary skill in the art having the benefit of this disclosure. However, in each case, the facial scanner creates a depth map of a three-dimensional object, such as a person's face. This depth map can then be compared to one or more predefined authentication reference files to confirm whether the contours, nooks, crannies, curvatures, and features of the person's face are that of an authorized user identified by the one or more predefined authentication references, which may include one or more predefined facial maps.

A second authenticator 302 comprises an imager. The imager can capture at least one image of an object situated within a predefined radius of an electronic device (102). In one embodiment, the imager captures a single image of the object. In another embodiment, the imager captures a plurality of images of the object. In one or more embodiments, the one or more images are each a two-dimensional image. For example, in one embodiment the image is a two-dimensional RGB image. In another embodiment, the image is a two-dimensional infrared image. Other types of two-dimensional images will be obvious to those of ordinary skill in the art having the benefit of this disclosure.

In one or more embodiments, the image can be compared to one or more predefined authentication references stored in a memory, which may include one or more predefined reference images. By making such a comparison, the second 302 authenticator can confirm whether the shape, skin tone, eye color, hair color, hair length, and other features identifiable in a two-dimensional image are that of the authorized user identified by the one or more predefined authentication references.

A third authenticator 303 can comprise a combined image processing system. The combined image processing system can use images and depth scans in combination for authentication purposes. Illustrating my example, in one or more embodiments the third authenticator 303 may compare images with the one or more predefined authentication references. The third authenticator 303 can then compare depth scans with the one or more one or more other predefined authentication references. Authentication will fail in one or more embodiments unless the image sufficiently corresponds to at least one of the one or more predefined authentication references and the depth scan sufficiently corresponds to at least one of the one or more other predefined authentication references.

The use of both images and depth scans as combined authentication factors can be superior to using one or the other alone. The depth scan adds a third “z-dimension” to the x-dimension and y-dimension data found in an image, thereby enhancing the security of using the user's face as their password in the process of authentication by facial recognition. Another benefit of using depth scans in conjunction with images is the prevention of someone “faking” the second authenticator 302 operating alone by taking an image of a picture of an authorized user, rather than of the actual authorized user. The inclusion of depth scans in conjunction with images prevents this type of chicanery by requiring that a three-dimensional object, i.e., the actual user, be present before the third authenticator 303 authenticates the person.

The third authenticator 303 can also include a thermal sensor to detect an amount of thermal energy received from an object within a thermal reception radius of an electronic device (102). In one or more embodiments, only where the amount of thermal energy received form the object is within a predefined temperature range will the third authenticator 303 authenticate a user. Advantageously, the inclusion of a thermal sensor prevents the use of three-dimensional masks from “tricking” the third authenticator 303 by masquerading as an authorized user.

In one or more embodiments, the third authenticator 303 can be directional so as to ensure that any received thermal energy is spatially aligned with the user's face. Depending upon the resolution of the third authenticator 303, the thermal signature should match that of a human face, e.g., the nose should be cooler than the rest of the face, while cheeks, neck, forehead, and eyes should each have their own temperature on a per-region basis. Thermal ripples may also indicate that the person moving their lips is actually talking as they release breath. The detectability of this is is dependent on the ambient temperature and resolution of the third authenticator 303.

A fourth authenticator 304 can be a fingerprint sensor. The fingerprint sensor can capture a fingerprint image that can be used to authenticate a user of an electronic device (102). As used herein, a fingerprint image refers to a digital image and/or any other type of data representing the print pattern features that distinctly identify a user by a fingerprint of a finger. The fourth authenticator 304 can also include a presence sensor that periodically detects a presence of a warm object near the fingerprint sensor. In implementations, a fingerprint sensor can also be implemented to detect user presence, rather than implementing a separate presence sensor.

A fifth authenticator 305 can comprise a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry to detect an object in close proximity with—or touching—the surface of an electronic device (102) by establishing electric field lines between pairs of capacitive sensors and then detecting perturbations of those field lines. The electric field lines can be established in accordance with a periodic waveform, such as a square wave, sine wave, triangle wave, or other periodic waveform that is emitted by one sensor and detected by another.

A sixth authenticator 306 can comprise a pincode receiver. The pincode receiver can receive a Personal Identification Number (PIN) code or a pass code from a user.

A seventh authenticator 307 can comprise a voice recognition engine. The voice recognition engine can comprise executable code, hardware, and various voice print templates (also referred to as “voice models”). The voice recognition engine can use the voice print templates to compare a voiceprint from received input and determine if a match exists. In operation, the voice recognition engine obtains voice data using at least one microphone. The voice recognition engine can extract voice recognition features from the voice data and generate a voiceprint. The voice recognition engine can compare the voiceprint to at least one predefined authentication reference, which may comprise a predefined voice print template.

An eighth authenticator 308 can comprise a location detector. The location detector can comprise a geo-locator. The location detector is able to determine location data of an electronic device (102) by capturing the location data from a constellation of one or more earth orbiting satellites, or from a network of terrestrial base stations to determine an approximate location.

A ninth authenticator 309 comprises an iris scanner. The iris scanner can capture images and/or thermal or infrared scans of a person's iris. The iris scanner can employ either or both of visible and near-infrared light. The iris scanner can capture high-contrast images of a person's iris, and can compare these images to one or more predefined authentication references to determine if there is a match. Where there is a match, the ninth authenticator 309 can determine that a person is an authorized user of an electronic device (102).

A tenth authenticator 310 can comprise an environmental sensor. The environmental sensor can sense or determine physical parameters indicative of conditions in an environment about an electronic device (102). Such conditions include weather determinations, noise determinations, lighting determinations, and so forth. Such conditions can also include barometric pressure, moisture levels, and temperature of an electronic device (102).

An eleventh authenticator 311 can comprise a context sensor. In contrast to the environmental sensor of the tenth authenticator 310, the context sensor of the eleventh authenticator 311 can infer context from data of the electronic device (102). Illustrating by example, the context sensor can use data captured in images to infer contextual cues. An emotional detector may be operable to analyze data from a captured image to determine an emotional state. The emotional detector may identify facial gestures such as a smile or raised eyebrow to infer a person's silently communicated emotional state, e.g. joy, anger, frustration, and so forth. The context sensor may analyze other data to infer context, including calendar events, user profiles, device operating states, energy storage within a battery, application data, data from third parties such as web services and social media servers, alarms, time of day, behaviors a user repeats, and other factors. Other context sensors will be obvious to those of ordinary skill in the art having the benefit of this disclosure. The context sensor can be configured as either hardware components, or alternatively as combinations of hardware components and software components. The context sensor can be configured to collect and analyze non-physical parametric data.

Turning now back to FIG. 2, in one or more embodiments the one or more processors 211 launch 213 or actuate at least a second authenticator when a first authenticator authenticates an authentication input 212 of a first type 214 and at least one sensor of the one or more sensors 201,202,203,204,205 detect an authentication input 212 of a second type 215.

Said differently, in one embodiment at least one sensor of the one or more sensors 201,202,203,204,205 receives an authentication input 212 of a first type 214 that identifies an authorized user of the electronic device 102. For example, the third authenticator 208 may be a facial recognition authenticator and the authentication input 212 of the first type 214 may be one or more of an RGB image of a user and/or a facial depth scan of the user. As described above with reference to FIG. 1, in one embodiment the third authenticator 208 will attempt to authenticate the authentication input 212 of the first type 214.

At the same time, in one or more embodiments a second sensor 202 receives another authentication input 212 of a second type 215. If, for example, the second authentication input 212 of the second type 215 is voice input, the second sensor 202 receiving the same may be a microphone. When this occurs, the one or more processors 211 can launch 213, activate, or actuate the second authenticator 207. In one or more embodiments, the second authenticator 207 is operable to authenticate the second input 212 of the second type 215. Thus, in this example the second authenticator 207 may be a voice recognition authenticator.

From this state, several different actions can occur. If the second authenticator 207 has not been configured to authenticate a particular user as an authorized user, the one or more processors 211 can train the second authenticator 207 to authenticate the authorized user using the second input 212 of the second type 215. As previously described, this training can include storing, with the second authenticator 207, in a memory 217 operable with the second authenticator 207, a data representation 220 of the another input 212 of the second type 215 as a predefined authentication reference. In this example, the data representation 220 may comprise a stored audio signal including pitch, tone, timbre, and cadence data identifying received audio as that of an authorized user. The one or more processors 211 may optionally identify that the training is occurring by presenting a prompt 216 on a display 218 of the electronic device 102.

Going forward, when another authentication input 219 of the second type 215 is received, the second authenticator 207 can attempt to authenticate the other authentication input 219 of the second type 215 by comparing it to the data representation 220 stored in memory 217.

If the second authenticator 207 has previously been configured to authenticate a particular user as an authorized user and another authentication input 219 of the second type 215 is received, the second authenticator 207 one or both of use the another authentication input 219 of the second type 215 to authenticate the user and/or modify the data representation 220 with the another authentication input 219 of the second type 215. Thus, the second authenticator 207 can allow access to the electronic device 102 upon authorized user authentication. Additionally, the other authentication input 219 of the second type 215 can be used to refine the data representation 220 so that authentication becomes more accurate.

In still other embodiments, when future authentication input is received authorization by multiple authenticators may be required to access the electronic device 102 and/or one or more applications operating on the electronic device 102. For instance, upon receiving another authentication input 219 of the first type 214 and another authentication input 219 of the second type 215, the third authenticator 208 will attempt to authenticate the another authentication input 219 of the first type 214 while the second authenticator 207 attempts to authenticate the another authentication input 219 of the second type 215. In one or more embodiments, the one or more processors 211 allow access to the electronic device 102 and/or a particular program running thereon only where the third authenticator 208 authenticates the other authentication input 219 of the first type 214 and the second authenticator 207 authenticates the other authentication input 219 of the second type 215.

Accordingly, a user may be authenticated by a facial scan. While the facial scan is occurring, another sensor may receive voice input. The electronic device 102 can optionally confirm that the voice input is coming from the mouth of the face being scanned by beam steering the audio sensor in one or more embodiments. Alternatively, the electronic device 102 can optionally confirm that the voice input is coming from the mouth of the face being scanned by capturing multiple images of the face and determining whether the mouth of the face in the images is moving in one or more embodiments. Other techniques for confirming that the second input is coming from the same source as the first input will be obvious to those of ordinary skill in the art having the benefit of this disclosure.

Upon confirming the voice input is coming from the mouth of the face being scanned, and upon the face scan confirming that the user is an authorized user, the one or more processors 211 can launch a second authenticator 207 and passively train, or passively revise training models, associated therewith. These steps can be “passive” in that they occur in the background or unbeknownst to the user. In one or more embodiments, these steps can occur without manual user manipulation of the electronic device 102.

Where multiple authenticators 206,207,208,209,210 are operational and an authentication input 212 is received, in one embodiment the one or more processors 211 may select 221 an appropriate authenticator 206,207,208,209,210 to be the primary authenticator. If, for example, a user is entering a pincode, such authentication input would not be suited for a facial scanning authenticator, a facial recognition authenticator, or a voice authenticator. Accordingly, the one or more processors 211 may select 221 a pincode authenticator to attempt to authenticate the user as an authorized user, and so forth.

The one or more processors 211 can also select 221 an appropriate authenticator 206,207,208,209,210 based upon the type of input 212. If, for example, multiple authenticators are operating on the electronic device 102, the one or more processors 211 can select 221 the authenticator 206,207,208,209,210 suitable for processing the input 212. If the input 212 is audio, the one or more processors 211 may select 221 a voice identification authenticator. If the input 212 is the presence of a user's face, the one or more processors 211 may select 221 a facial depth scan authenticator, a RGB image authenticator, or a combination thereof. If the input 212 is a fingerprint, the one or more processors 211 may select 221 a fingerprint sensor as the authenticator.

In still other embodiments, the one or more processors 211 can select 221 the appropriate authenticator 206,207,208,209,210 based upon contextual cues learned from a context sensor. Illustrating by example, consider the situation where a person is both looking at the electronic device 102 and speaking. If both a voice authentication authenticator and a facial scanning authenticator are operational, either could be used to unlock the electronic device 102. However, if the context sensors determine that the electronic device 102 is in a noisy environment, the one or more processors 211 may conclude that the voice recognition authentication is less reliable than would be the facial scan authentication. Accordingly, the one or more processors 211 may select 221 the facial scanning authenticator to perform the authentication.

By contrast, in the same situation of the context sensors determine that there are three people facing the electronic device 102, the one or more processors 211 may conclude that facial scanning is less reliable than the voice recognition, and therefore may select 221 the voice recognition authenticator. It should be noted that the selection 221 need not be limited to a single authenticator 206,207,208,209,210. To the contrary, the one or more processors 211 may select 221 two, three, four, or more authenticators 206,207,208,209,210. These authenticators 206,207,208,209,210 may be selected as a function of the input, a function of detected context, or combinations thereof.

In still other examples, the one or more processors 211 can select 221 the appropriate authenticator 206,207,208,209,210 based upon environmental cues learned from a context sensor. For example, if environmental lighting is poor, and a facial recognition authenticator is the highest priority or primary authenticator, in one or more embodiments the one or more processors 211 will override this setting and select 221, perhaps, a voice authenticator as the primary authenticator. Similarly, if a user is detected as being far from the electronic device 102 and an iris scanner is the primary authenticator, in one or more embodiments the one or more processors 211 will override this setting and select 221, perhaps, a voice authenticator as the primary authenticator. In sum, in one or more embodiments the one or more processors 211 will override a primary authenticator as a function of environmental conditions and and select 221 a secondary authenticator as the primary authenticator.

Turning now to FIG. 4, illustrated therein is one explanatory block diagram schematic 400 of one explanatory electronic device 102 configured in accordance with one or more embodiments of the disclosure. While a smartphone has been used to this point as an illustrative electronic device 102, it should be noted that the electronic device 102 can be other types of devices as well. In other embodiments, the electronic device 102 can be a conventional desktop computer, palm-top computer, tablet computer, gaming device, media player, wearable device, or other device. Still other devices will be obvious to those of ordinary skill in the art having the benefit of this disclosure.

In one or more embodiments, the block diagram schematic 400 is configured as a printed circuit board assembly disposed within a housing 401 of the electronic device 102. Various components can be electrically coupled together by conductors or a bus disposed along one or more printed circuit boards.

The illustrative block diagram schematic 400 of FIG. 4 includes many different components. Embodiments of the disclosure contemplate that the number and arrangement of such components can change depending on the particular application. Accordingly, electronic devices configured in accordance with embodiments of the disclosure can include some components that are not shown in FIG. 4, and other components that are shown may not be needed and can therefore be omitted.

The illustrative block diagram schematic 400 includes a user interface 402. In one or more embodiments, the user interface 402 includes a display 403, which may optionally be touch-sensitive. In one embodiment, users can deliver user input to the display 403 of such an embodiment by delivering touch input from a finger, stylus, or other objects disposed proximately with the display 403. In one embodiment, the display 403 is configured as an active matrix organic light emitting diode (AMOLED) display. However, it should be noted that other types of displays, including liquid crystal displays, suitable for use with the user interface 402 would be obvious to those of ordinary skill in the art having the benefit of this disclosure.

In one embodiment, the electronic device includes one or more processors 211. In one embodiment, the one or more processors 211 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 400. Each of the application processor and the auxiliary processor(s) can be configured to process and execute executable software code to perform the various functions of the electronic device with which the block diagram schematic 400 operates. A storage device, such as memory 405, can optionally store the executable software code used by the one or more processors 211 during operation.

In this illustrative embodiment, the block diagram schematic 400 also includes a communication circuit 406 that can be configured for wired or wireless communication with one or more other devices or networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, GPRS networks, iDEN networks, and other networks. The communication circuit 406 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology. The communication circuit 406 can include wireless communication circuitry, one of a receiver, a transmitter, or transceiver, and one or more antennas.

In one embodiment, the one or more processors 211 can be responsible for performing the primary functions of the electronic device with which the block diagram schematic 400 is operational. For example, in one embodiment the one or more processors 211 comprise one or more circuits operable with the user interface 402 to present presentation information to a user. The executable software code used by the one or more processors 211 can be configured as one or more modules 407 that are operable with the one or more processors 211. Such modules 407 can store instructions, control algorithms, and so forth.

In one or more embodiments, the block diagram schematic 400 includes an audio input/processor 409. The audio input/processor 409 can include hardware, executable code, and speech monitor executable code in one embodiment. The audio input/processor 409 can be operable with one or more predefined authentication references 416 stored in memory 405. With reference to audio input, the predefined authentication references 416 can comprise representations of basic speech models, representations of trained speech models, or other representations of predefined audio sequences that are used by the audio input/processor 409 to receive and identify voice commands that are received with audio input captured by an audio capture device. In one embodiment, the audio input/processor 409 can include a voice recognition engine. Regardless of the specific implementation utilized in the various embodiments, the audio input/processor 409 can access various speech models stored with the predefined authentication references 416 to identify speech commands.

The audio input/processor 409 can include a beam steering engine 404 comprising one or more microphones 420. In one or more embodiments, two or more microphones 420 can be included for selective beam steering by the beam steering engine 404. For example a first microphone can be located on a first side of the electronic device 102 for receiving audio input from a first direction. Similarly, a second microphone can be placed on a second side of the electronic device 102 for receiving audio input from a second direction.

The beam steering engine 404 can then select between the first microphone and the second microphone to beam steer audio reception toward an object, such as a user delivering audio input. This beam steering can be responsive to input from other sensors, such as imagers, facial depth scanners, thermal sensors, or other sensors. For example, an imager can estimate a location of a person's face and deliver signals to the beam steering engine 404 alerting it in which direction to steer the first microphone and the second microphone. Where multiple people are around the electronic device 100, this steering advantageously directs a beam reception cone to the authorized user, rather than to others who are not authorized to use the electronic device 100.

Alternatively, the beam steering engine 404 processes and combines the signals from two or more microphones to perform beam steering. The one or more microphones 420 can be used for voice commands. In response to control of the one or more microphones 420 by the beam steering engine 404, a user location direction can be determined. The beam steering engine 404 can then select between the first microphone and the second microphone to beam steer audio reception toward the user. Alternatively, the audio input/processor 409 can employ a weighted combination of the microphones to beam steer audio reception toward the user.

In one embodiment, the audio input/processor 409 is configured to implement a voice control feature that allows a user to speak a specific device command to cause the one or more processors 211 to execute a control operation. For example, the user may say, “Authenticate Me Now.” This statement comprises a device command requesting the one or more processors to cooperate with the authentication system 411 to authenticate a user. Consequently, this device command can cause the one or more processors 211 to access the authentication system 411 and begin the authentication process. In short, in one embodiment the audio input/processor 409 listens for voice commands, processes the commands and, in conjunction with the one or more processors 211, performs a touchless authentication procedure in response to voice input.

Various sensors 408 can be operable with the one or more processors 211. FIG. 3 above illustrated several examples such sensors. It should be noted that those shown in FIG. 4 are not comprehensive, as others will be obvious to those of ordinary skill in the art having the benefit of this disclosure. Additionally, it should be noted that the various sensors shown in FIG. 4 could be used alone or in combination. Accordingly, many electronic devices will employ only subsets of the sensors shown in FIG. 4, with the particular subset defined by device application.

A first example of a sensor that can be included with the various sensors 408 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 211, to detect an object in close proximity with—or touching—the surface of the display 403 or the housing 401 of the electronic device 102 by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques.

Another example of a sensor is a geo-locator that serves as a location detector 410. In one embodiment, location detector 410 is able to determine location data when authenticating a user and/or training one of the authenticators of the authentication system. Location can be determined by capturing the location data from a constellation of one or more earth orbiting satellites, or from a network of terrestrial base stations to determine an approximate location. Examples of satellite positioning systems suitable for use with embodiments of the present invention include, among others, the Navigation System with Time and Range (NAVSTAR) Global Positioning Systems (GPS) in the United States of America, the Global Orbiting Navigation System (GLONASS) in Russia, and other similar satellite positioning systems. The satellite positioning systems based location fixes of the location detector 410 autonomously or with assistance from terrestrial base stations, for example those associated with a cellular communication network or other ground based network, or as part of a Differential Global Positioning System (DGPS), as is well known by those having ordinary skill in the art. The location detector 410 may also be able to determine location by locating or triangulating terrestrial base stations of a traditional cellular network, such as a CDMA network or GSM network, or from other local area networks, such as Wi-Fi networks.

One or more motion detectors can be configured as an orientation detector 421 that determines an orientation and/or movement of the electronic device 102 in three-dimensional space. Illustrating by example, the orientation detector 421 can include an accelerometer, gyroscopes, or other device to detect device orientation and/or motion of the electronic device 102. Using an accelerometer as an example, an accelerometer can be included to detect motion of the electronic device. Additionally, the accelerometer can be used to sense some of the gestures of the user, such as one talking with their hands, running, or walking.

The orientation detector 421 can determine the spatial orientation of an electronic device 102 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 102.

An authentication system 411 can be operable with the one or more processors 211. The authentication system 411 can comprise any of the authenticators of FIG. 3, either alone or in combination. Other authenticators can be included as well.

For example, a first authenticator 422 of the authentication system 411 can include an imager 423, a depth imager 424, and a thermal sensor 425. In one embodiment, the imager 423 comprises a two-dimensional imager configured to receive at least one image of a person within an environment of the electronic device 102. In one embodiment, the imager 423 comprises a two-dimensional Red-Green-Blue (RGB) imager. In another embodiment, the imager 423 comprises an infrared imager. Other types of imagers suitable for use as the imager 423 of the authentication system will be obvious to those of ordinary skill in the art having the benefit of this disclosure.

The thermal sensor 425 can also take various forms. In one embodiment, the thermal sensor 425 is simply a proximity sensor component included with the other components 426. In another embodiment, the thermal sensor 425 comprises a simple thermopile. In another embodiment, the thermal sensor 425 comprises an infrared imager that captures the amount of thermal energy emitted by an object. Other types of thermal sensors 425 will be obvious to those of ordinary skill in the art having the benefit of this disclosure.

The depth imager 424 can take a variety of forms. Turning briefly to FIG. 5, illustrated therein are three different configurations of the first authenticator 422 of the authentication system (411), each having a different depth imager 424.

In a first embodiment 501, the depth imager 504 comprises a pair of imagers separated by a predetermined distance, such as three to four images. This “stereo” imager works in the same way the human eyes do in that it captures images from two different angles and reconciles the two to determine distance.

In another embodiment 502, the depth imager 505 employs a structured light laser. The structured light laser projects tiny light patterns that expand with distance. These patterns land on a surface, such as a user's face, and are then captured by an imager. By determining the location and spacing between the elements of the pattern, three-dimensional mapping can be obtained.

In still another embodiment 503, the depth imager 506 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, the depth imager 504,505,506 adds a third “z-dimension” to the x-dimension and y-dimension defining the two-dimensional image captured by the imager 423, thereby enhancing the security of using a person's face as their password in the process of authentication by facial recognition.

Turning back to FIG. 4, the authentication system 411 can be operable with a face analyzer 419 and an environmental analyzer 414. The face analyzer 419 and/or environmental analyzer 414 can be configured to process an image or depth scan of an object and determine whether the object matches predetermined criteria by comparing the image or depth scan to one or more predefined authentication references 416 stored in memory 405.

For example, the face analyzer 419 and/or environmental analyzer 414 can operate as an authentication module configured with optical and/or spatial recognition to identify objects using image recognition, character recognition, visual recognition, facial recognition, color recognition, shape recognition, and the like. Advantageously, the face analyzer 419 and/or environmental analyzer 414, operating in tandem with the authentication system 411, can be used as a facial recognition device to determine the identity of one or more persons detected about the electronic device 102.

In one embodiment when the authentication system 411 detects a person, one or both of the imager 423 and/or the depth imager 424 can capture a photograph and/or depth scan of that person. The authentication system 411 can then compare the image and/or depth scan to one or more predefined authentication references 416 stored in the memory 405. This comparison, in one or more embodiments, is used to confirm beyond a threshold authenticity probability that the person's face—both in the image and the depth scan—sufficiently matches one or more of the predefined authentication references 416 stored in the memory 405 to authenticate a person as an authorized user of the electronic device 102.

Beneficially, this optical recognition performed by the authentication system 411 operating in conjunction with the face analyzer 419 and/or environmental analyzer 414 allows access to the electronic device 102 only when one of the persons detected about the electronic device are sufficiently identified as an authorized user of the electronic device 102. Accordingly, in one or more embodiments the one or more processors 211, working with the authentication system 411 and the face analyzer 419 and/or environmental analyzer 414 can determine whether at least one image captured by the imager 423 matches a first predefined criterion, whether at least one facial depth scan captured by the depth imager 424 matches a second predefined criterion, and whether the thermal energy identified by the thermal sensor 425 matches a third predefined criterion, with the first criterion, second criterion, and third criterion being defined by the reference files and predefined temperature range. The first criterion may be a skin color, eye color, and hair color, while the second criterion is a predefined facial shape, ear size, and nose size. The third criterion may be a temperature range of between 95 and 101 degrees Fahrenheit. In one or more embodiments, the one or more processors 211 authenticate a person as an authorized user of the electronic device 102 when the at least one image matches the first predefined criterion, the at least one facial depth scan matches the second predefined criterion, and the thermal energy matches the third predefined criterion.

In one or more embodiments, a user can “train” the electronic device 102 by storing predefined authentication references 416 in the memory 405 of the electronic device 102. Illustrating by example, a user may take a series of pictures. They can include identifiers of special features such as eye color, sink color, air color, weight, and height. They can include the user standing in front of a particular wall, which is identifiable by the environmental analyzer from images captured by the imager 423. They can include the user raising a hand, touching hair, or looking in one direction, such as in a profile view. These can then be stored as predefined authentication references 416 in the memory 405 of the electronic device 102.

A gaze detector 412 can be operable with the authentication system 411 operating in conjunction with the face analyzer 419. The gaze detector 412 can comprise sensors for detecting the user's gaze point. The gaze detector 412 can optionally include sensors for detecting the alignment of a user's head in three-dimensional space. Electronic signals can then be processed for computing the direction of user's gaze in three-dimensional space. The gaze detector 412 can further be configured to detect a gaze cone corresponding to the detected gaze direction, which is a field of view within which the user may easily see without diverting their eyes or head from the detected gaze direction. The gaze detector 412 can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector 412 of FIG. 4.

The face analyzer 419 can include its own image/gaze detection-processing engine as well. The image/gaze detection-processing engine can process information to detect a user's gaze point. The image/gaze detection-processing engine can optionally also work with the depth scans to detect an alignment of a user's head in three-dimensional space. Electronic signals can then be delivered from the imager 423 or the depth imager 424 for computing the direction of user's gaze in three-dimensional space. The image/gaze detection-processing engine can further be configured to detect a gaze cone corresponding to the detected gaze direction, which is a field of view within which the user may easily see without diverting their eyes or head from the detected gaze direction. The image/gaze detection-processing engine can be configured to alternately estimate gaze direction by inputting images representing a photograph of a selected area near or around the eyes. It can also be valuable to determine if the user wants to be authenticated by looking directly at device. The image/gaze detection-processing engine can determine not only a gazing cone but also if an eye is looking in a particular direction to confirm user intent to be authenticated.

Other components 426 operable with the one or more processors 211 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 426 can also include proximity sensors. The proximity sensors fall in to one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 401 of the electronic device 102. In one embodiment, the signal receiver is an infrared signal receiver to receive an infrared emission from an object such as a human being when the human is proximately located with the electronic device 102. In one or more embodiments, the proximity sensor component is configured to receive infrared wavelengths of about four to about ten micrometers. This wavelength range is advantageous in one or more embodiments in that it corresponds to the wavelength of heat emitted by the body of a human being.

Additionally, detection of wavelengths in this range is possible from farther distances than, for example, would be the detection of reflected signals from the transmitter of a proximity detector component. In one embodiment, the proximity sensor components have a relatively long detection range so as to detect heat emanating from a person's body when that person is within a predefined thermal reception radius. For example, the proximity sensor component may be able to detect a person's body heat from a distance of about ten feet in one or more embodiments. The ten-foot dimension can be extended as a function of designed optics, sensor active area, gain, lensing gain, and so forth.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 211 can cause each proximity sensor component to operate at a first “effective” sensitivity so as to receive infrared emissions from a first distance. Similarly, the one or more processors 211 can cause each proximity sensor component to operate at a second sensitivity, which is less than the first sensitivity, so as to receive infrared emissions from a second distance, which is less than the first distance. The sensitivity change can be effected by causing the one or more processors 211 to interpret readings from the proximity sensor component differently.

By contrast, proximity detector components include a signal emitter and a corresponding signal receiver, which constitute an “active IR” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 426 can optionally include a barometer operable to sense changes in air pressure due to elevation changes or differing pressures of the electronic device 102. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 426 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 102. Similarly, a temperature sensor can be configured to monitor temperature about an electronic device.

A context engine 413 can then operable with the various sensors to detect, infer, capture, and otherwise determine persons and actions that are occurring in an environment about the electronic device 102. For example, where included one embodiment of the context engine 413 determines assessed contexts and frameworks using adjustable algorithms of context assessment employing information, data, and events. These assessments may be learned through repetitive data analysis. Alternatively, a user may employ the user interface 402 to enter various parameters, constructs, rules, and/or paradigms that instruct or otherwise guide the context engine 413 in detecting multi-modal social cues, emotional states, moods, and other contextual information. The context engine 413 can comprise an artificial neural network or other similar technology in one or more embodiments.

In one or more embodiments, the context engine 413 is operable with the one or more processors 211. In some embodiments, the one or more processors 211 can control the context engine 413. In other embodiments, the context engine 413 can operate independently, delivering information gleaned from detecting multi-modal social cues, emotional states, moods, and other contextual information to the one or more processors 211. The context engine 413 can receive data from the various sensors. In one or more embodiments, the one or more processors 211 are configured to perform the operations of the context engine 413.

In one or more embodiments, the one or more processors 211 can be operable with the various authenticators of the authentication system 411. For example, the one or more processors 211 can be operable with a first authenticator and a second authenticator. Where more authenticators are included in the authentication system 411, such as those shown in FIGS. 2 and 3 above, the one or more processors 211 can be operable with these authenticators as well.

In one or more embodiments, the one or more processors 211 are operable to actuate a first authenticator to authenticate authentication input of a first type. The first authenticator could be any number of authenticators. The first authenticator may one of an imager, or a fingerprint sensor, or any of the authenticators of FIG. 3, alone or in combination. For example, the first authenticator may be the third authenticator (303) of FIG. 3, which employs a combined imager and depth scanner, and optionally a thermal sensor. The one or more processors 211 can actuate this authenticator to authenticate a person as an authorized user using a facial recognition process.

In one or more embodiments, the one or more processors 211 can then actuate a second authenticator where the first authenticator authenticates the authentication input of the first type and one or more sensors, such as the sensors (201,202,203,204,205) of FIG. 2, detect an authentication input of a second type. The second authenticator could be any number of authenticators. The second authenticator could be one of a voice interface engine or a touch-sensitive user interface. Illustrating by example, if the first authenticator may be the third authenticator (303) of FIG. 3 authenticates a person using facial recognition, but another sensor receives audio input at the same time, the one or more processors 211 may actuate and/or launch the seventh authenticator (307) from FIG. 3.

As noted above, the one or more processors 211 can cause the second authenticator to either be trained by the received audio input or, if already trained, to refine one or more predefined authentication references 416 stored in memory 405 with the audio input. Illustrating by example, in one embodiment the second authenticator would store a data representation 430 of the authentication input of the second type in the memory 405 as a predefined authentication reference 416. By contrast, where the predefined authentication references 416 already included a reference having the identifiable characteristics of the audio input, the second authenticator may modify the data representation 430 of the second type with the received authentication input of the second type. Thus, an authorized user's voiceprint may be refined with the audio input to become a more precise voiceprint.

In so doing, the next time a person attempts to authenticate himself or herself, they may use either the first authenticator or the second authenticator to do so. Alternatively, the authenticators can be layered to provide a higher level of security. For example, upon receiving another authentication input of the first type and another authentication input of the second type, the first authenticator may attempt to authenticate the another authentication input of the first type while the second authenticator attempts to authenticate the another authentication input of the second type. For higher level security applications including private or other highly secure data, in one or more embodiments the one or more processors 211 allow access to the electronic device 102 only where the first authenticator authenticates the another authentication input of the first type and the second authenticator authenticates the another authentication input of the second type. Three, four, five, or more authenticators can be layered in this manner.

Embodiments of the disclosure thus advantageously provide methods and systems for launching a second authenticator while a first authenticator is in operation. In one or more embodiments, one or more sensors of the electronic device 102 receive an authentication input of a first type. The authentication input identifies an authorized user of the electronic device 102. The electronic device 102 therefore attempts to authenticate, with a first authenticator, the authentication input.

When another input of a second type that also identifies the authorized user of the electronic device 102 is received, such as when a voice input is received while a facial depth scan authentication is occurring, the one or more processors 211 may launch at least a second authenticator to enable multiple authenticators to allow access to the electronic device 102 with minimal interaction with the authorized user. The second authenticator can then process the second input. This processing can include storing the second input, or representations thereof, in memory 405 as a predefined authentication reference 416, refining predefined authentication references 416 of the second type with the second input, or other processing.

Illustrating by example, in one embodiment the first authenticator can comprise a facial depth scanner, such as the first authenticator (301) of FIG. 3. Accordingly, a person may look at the electronic device 102 so that the facial depth scanner can scan the person's face. This scan can then be compared to a predefined authentication reference 416 stored in memory 405 so that one or more processors 211 can determine whether the person is an authorized user of the electronic device 102. If so, the electronic device 102 can be unlocked. If not, the electronic device 102 can remain locked.

Now consider the situation where the person is also talking while the facial depth scan is occurring. In one or more embodiments, the one or more processors 211 can detect reception of the person's voice as a second form of input that is different from the first input. To provide a more seamless user experience, in one or more embodiments the one or more processors 211 can then launch a voice authenticator, such as the seventh authenticator (307) of FIG. 3. If the voice authenticator has not been used before, once the facial depth scan is confirmed as that of the authorized user, a digital representation of the voice input can be stored in memory 405 as a predefined authentication reference 416. Accordingly, and advantageously, the next time the user accesses the electronic device 102 either the facial depth scan or voice recognition can be used to authenticate the user.

In other embodiments, such as where a predefined voice authentication reference 416 exists in memory 405 due to the fact that the voice recognition authenticator has been used before, once the facial depth scan is confirmed as that of the authorized user, this predefined authentication reference 416 can be further refined with the voice input to more accurately be used in authentication of the person as an authorized user. Other processing operations using the second input will be obvious to those of ordinary skill in the art having the benefit of this disclosure.

In one embodiment, when someone is speaking, a voice authenticator monitors and syncs received audible signals from an authorized user. An image authenticator may capture images of the person's face. A location authenticator can determine the location of the electronic device. Where a first authenticator, such as a facial depth scanner, authenticates the person as an authorized user of the electronic device 102, received audio can be tagged as belonging to the authorized user and stored in memory 405 as a predefined audio authentication reference 416. This predefined authentication reference 416 can then be used in the future as a second technique, i.e., voice recognition, to authenticate a person as an authorized user. Note that in one or more embodiments this launch of the second authenticator while a first authenticator is operational is “passive” in that the user does not interact with the electronic device 102 to affirmatively launch the second authenticator. To the contrary, in this example, one method of authentication, e.g., the use of a facial depth scanner, can enable a second method of authentication, e.g., voice recognition, by association in the background to offer additional authentication features to a user automatically.

In one or more embodiments, authentication made by the second authenticator, which was passively launched initially, can be supplemented by the use of contextual information. For instance, in the situation where a person was at one time talking while a facial depth scan was occurring, and this caused the launch of a voice recognition authenticator, which used the received audio to create a predefined authentication reference 416, in one or more embodiments a location authenticator, such as the eight authenticator (308) of FIG. 3, determines the location of the electronic device 102 while the audio input is being received. Going forward, in one or more embodiments when authentication by voice recognition, i.e., by the second authenticator, occurs, location can be used to provide an additional level of confirmation that the person being authenticated is in fact an authorized user.

Illustrating by example, if the voice input was initially captured in a person's home, or their car, or their office, this location can be stored when received audio is used to create a predefined authentication reference 416. When subsequent voice recognition authentication steps occur, and the person is in the same location, i.e., in the home, car, or office, the fact that voice authentication is occurring in the same location that the initial training of the second authenticator occurred can provide additional level of confirmation that the person being authenticated is in fact an authorized user. Other examples of contextual input include level a light level higher than a predefined level, device and/or user motion below certain level, and so forth.

In one or more embodiments, contextual information can also be used to preclude the launch of the second authenticator despite the fact that second authentication input is being received when a primary authenticator is authenticating first authentication input. Said differently, in one or more embodiments methods and systems determine, with the one or more sensors, such as the tenth authenticator (310) of FIG. 3, whether environmental conditions match one or more predefined criteria. The one or more processors 211 can then preclude storing any secondary input as a predefined authentication reference 416, or alternatively preclude refining any previously stored predefined authentication reference 416, unless the environmental conditions match the one or more predefined criteria.

Illustrating by example, when second authentication input is being received when a primary authenticator is authenticating first authentication input, and the second authentication input is acoustic input, the one or more processors 211 may determine that there is too much ambient noise from the tenth authenticator (310) to properly create a predefined authentication reference 416. Accordingly, in such a situation the one or more processors 211 may preclude storing any secondary input as a predefined authentication reference 416, or alternatively preclude refining any previously stored predefined authentication reference 416 because the ambient noise level fails to fall below a predefined ambient noise level threshold.

Similarly, when second authentication input is being received when a primary authenticator is authenticating first authentication input, and the second authentication input is a facial depth scan, the one or more processors 211 may determine that multiple people are found within captured images. This may interfere with properly scanning the authorized user. As such, the one or more processors 211 may preclude storing any secondary input as a predefined authentication reference 416, or alternatively preclude refining any previously stored predefined authentication reference 416 because the number of people near the electronic device 102 fails to fall below a predefined person quantity threshold, such as one person.

The fact that second authenticators can be launched while primary authenticators are authenticating primary input offers several advantages. For instance, passively training the second authenticator with second output allows the second authenticator to be used as the primary authenticator in the future. While an electronic device 102 may initially allow authentication only by facial depth scan, the launch and training of a voice recognition authenticator during facial authentication allows a user to unlock the electronic device 102 using voice in situations where they are not facing the facial scanner.

In other embodiments, the second authenticator can be layered upon the first authenticator. Embodiments of the disclosure contemplate that some applications will require a higher level of authentication than others. For instance, applications handling financial account information, health information, social security numbers, genome sequences, or other information may require higher levels of authentication than do applications for crossword puzzles, the weather, or sports scores. In one or more embodiments, a combination of two, three, four, or more authenticators. Advantageously, the passive launch and training of authenticators beyond a primary authenticator allows such higher-level authentication to occur without the user having to manually train each authenticator during device setup.

Accordingly, in one or more embodiments one form of authentication passively launches other forms of authentication, thereby enabling those other forms of authentication for future use. For instance, when a person enters a passcode, a facial recognition device may capture a Red-Green-Blue (RGB) image of the person entering the passcode, a facial depth scan of the person entering the passcode, or a combination thereof, so that facial recognition can be used for authentication in the future. If only the RGB image is initially used in facial recognition, during the next iteration this can launch a facial depth scanner to add it to the number of authenticators. Similarly, if the facial recognition is used in the next authentication, and the person is speaking, this can launch a third or fourth authenticator configured for voice authentication. Moreover, as noted above, contextual information such as location can add another level of confirmation. The contextual information can also be used to preclude passive authentication training or refining in certain conditions as noted above.

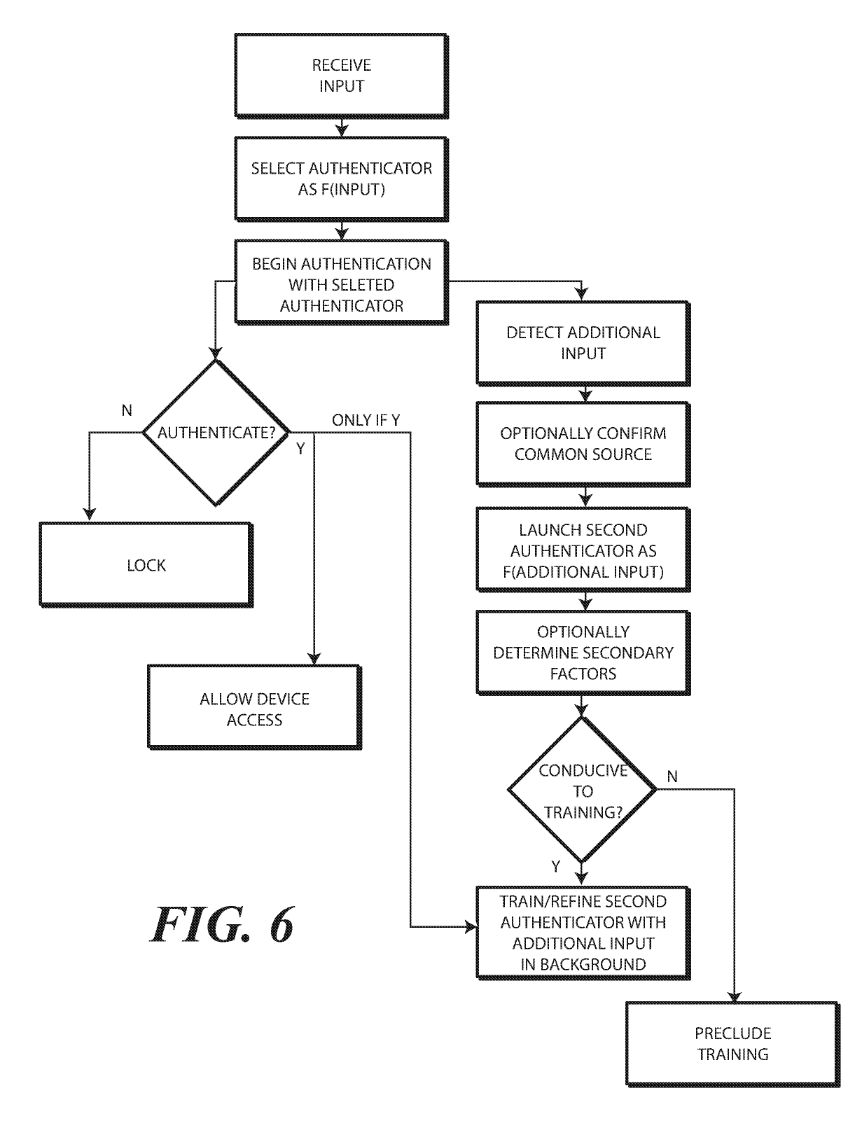

Turning now to FIG. 6, illustrated therein is one explanatory method 600 configured in accordance with one or more embodiments of the disclosure. At step 601, the method 600 receives, with one or more sensors carried by an electronic device, an authentication input of a first type. In one or more embodiments, the authentication input of the first type identifies an authorized user of the electronic device. Examples of the authentication input of the first type include a fingerprint scan, a pincode, a pass code, a facial depth scan, a facial image, an iris, scan, or a voice print. Other examples of authentication input of the first type will be obvious to those of ordinary skill in the art having the benefit of this disclosure.

At step 602, the method 600 selects an authenticator to attempt to authenticate the authentication input of the first type. Illustrating by example, where multiple authenticators are operational and the authentication input of the first type is received, step 602 may select an appropriate authenticator to be the primary authenticator. If, for example, a user is entering a pincode, such authentication input would not be suited for a facial scanning authenticator, a facial recognition authenticator, or a voice authenticator. Accordingly, step 602 may select a pincode authenticator to attempt to authenticate the user as an authorized user, and so forth.

Step 602 can comprise selecting an appropriate authenticator based upon the type of input. Alternatively, step 602 can select the appropriate authenticator based upon contextual cues learned from a context sensor. In other embodiments, step 602 can select the appropriate authenticator based upon environmental cues learned from a context sensor. For example, if environmental lighting is poor, and a facial recognition authenticator is the highest priority or primary authenticator, in one or more embodiments step 602 will override this setting and select, perhaps, a voice authenticator as the primary authenticator. Similarly, if a user is detected as being far from the electronic device and an iris scanner is the primary authenticator, in one or more embodiments step 602 will override this setting and select, perhaps, a voice authenticator as the primary authenticator.

At step 603, the method 600 includes attempting to authenticate, with the first authenticator, the authentication input of the first type. Decision 603 determines whether the authentication input of the first type sufficiently matches one or more predefined authentication references of the first type stored in a memory of the electronic device. Where it does, step 606 allows access to the electronic device. Where it does not, step 605 precludes access to the electronic device, and can comprise locking the electronic device.

At step 607, the method 600 detects, with one or more processors, reception of another input of a second type. In one or more embodiments, the other input of the second type also identifies the authorized user of the electronic device. Examples of the other authentication input of the second type include a fingerprint scan, a pincode, a pass code, a facial depth scan, a facial image, an iris, scan, or a voice print.

In one or more embodiments, the other identification input of the second type detected at step 607 is different from the authentication input of the first type received at step 601. For example, if the authentication input of the first type received at step 601 is a facial depth scan, the second type detected at step 607 may be a fingerprint. If the authentication input of the first type received at step 601 is a voiceprint scan, the second type detected at step 607 may be entry of a pincode, and so forth.

At step 608, the method 600 can optionally confirm, with the one or more sensors, that the other input of the second type originates from the authorized user of the electronic device. For example, if the authentication input of the first type is a facial depth scan, and the other authentication input of the second type is voice input, an imager may capture multiple pictures of the person being scanned in the facial depth scan. One or more processors may then process the contents of the images to determine whether the person being scanned in the facial depth scan is moving their lips. Alternatively, a beam steering engine may direct its audio reception beam in the direction of the person being scanned in the facial depth scan to confirm that the voice input is coming from the person being scanned in the facial depth scan and not another person nearby. Accordingly, in one or more embodiments step 608 comprises one of detecting, with a first sensor, lip movement of the authorized user or that audio originates within a predefined beam cone corresponding to the authorized user.

At step 609, in one or more embodiments the method 600 launches, with one or more processors, at least a second authenticator. Where optional step 608 is included, step 609 can comprise launching only where the one or more sensors confirm the other input of the second type originates from the authorized user.

At optional step 610, the method 600 can include capturing one or more secondary factors. These secondary factors can help determine, at decision 611, whether training of a secondary authenticator is appropriate. For example, decision 611 comprises determining, with the one or more sensors, whether environmental conditions match one or more predefined criteria. Where they do, training of the secondary authenticator can occur at step 612. By contrast, step 613 comprises precluding the training unless the environmental conditions match the one or more predefined criteria.

In one or more embodiments, the predefined criteria determined at decision 611 comprise an environmental noise level falling below a predefined noise threshold. Accordingly, in one embodiment an environmental noise level would be determined at step 610. At decision 611, this environmental noise level could be compared to a predefined noise threshold. The predefined noise threshold may define a sound pressure level or decibel level above which, for example, voice data would be degraded to the point where creating a predefined authentication reference would not be suitable.

In one or more embodiments, the predefined criteria determined at decision 611 comprise a number of persons within a predefined environment of the electronic device being only one person. Accordingly, in one embodiment a number of persons within a predefined environment of the electronic device, such as a radius of six feet, would be determined at step 610. At decision 611, this number of persons could be compared to a predefined number such as one person. The predefined number may define a condition at which a facial recognition process could be performed with sufficient quality.

In yet another embodiment, the predefined criteria determined at decision 611 comprise a location of the electronic device being a predefined location selected from a predefined set of locations stored within the memory of the electronic device. Accordingly, a location of the electronic device can be determined at step 610. This can be compared to a predefined set of locations, e.g., a person's home, car, workplace, at decision 611. In one or more embodiment, step 613 comprises precluding the training of step 612 unless the location matches a predefined location selected from a predefined set of locations stored within the memory of the electronic device.

Where conditions are appropriate for training as determined by decision 611, processing of the other input of the second type can occur at step 612. This processing can take one of two forms. If the second authenticator has not been trained, in one embodiment step 612 comprises storing, with the second authenticator, in a memory operable with the second authenticator, one or more digital representations of the other input of the second type as a predefined authentication reference. When future input of the second type, the method 600 can return to steps 601-604 and can attempt to authenticate, with the second authenticator, the input of the second type by comparing it to the predefined authentication reference.

By contrast, where the second authenticator has previously been trained, step 612 can comprise revising, with the second authenticator, the predefined authentication reference with the other authentication input of the second type. When future input of the second type, the method 600 can return to steps 601-604 and can attempt to authenticate, with the second authenticator, the input of the second type by comparing it to the predefined authentication reference.

Embodiments of the disclosure contemplate that it can be advantageous to alert a user to the fact that training of the second authenticator and/or revising any predefined authentication references is occurring. Accordingly, at optional step 614, the method 600 includes identifying, on a user interface of the electronic device, that the training is occurring. Since two authenticators will be available to authenticate the user after the second authenticator is trained. Accordingly, in one or more embodiments optional step 615 comprises receiving user input, at a user interface of the electronic device, that prioritizes one of the first authenticator or the second authenticator over another of the first authenticator or the second authenticator.

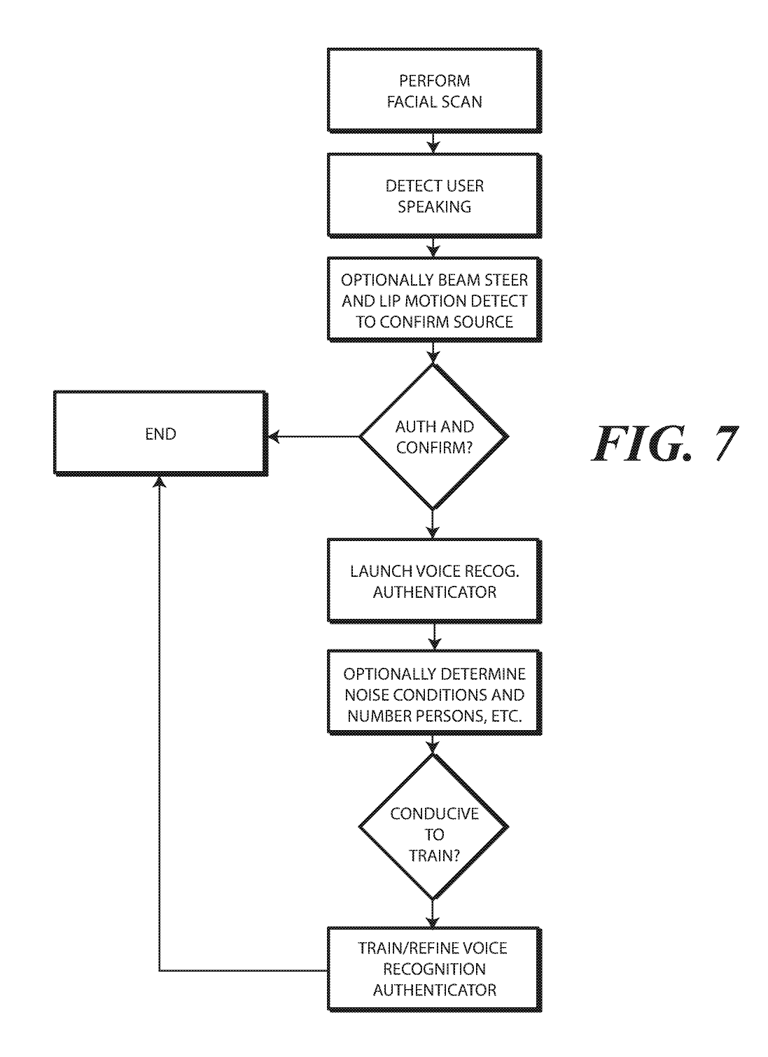

Turning now to FIG. 7, illustrated therein is one use case 700 to illustrate one example of the method (600) of FIG. 6. Beginning at step 701, a facial scan of a user is performed in an attempt to authenticate the user as an authorized user of an electronic device. At step 702, voice input is detected while the facial scan of step 701 is occurring.

At optional step 703, to confirm whether the voice input is coming from the person undergoing the facial scan at step 701, a beam steering engine causes a first sensor, such as a pair of steerable microphones, whether the audio originates within a predefined beam cone corresponding to the person undergoing the facial scan at step 701. Alternatively, step 703 can comprise analyzing one or more images to detect lip movement by the person undergoing the facials scan at step 701.

Decision 704 determines whether the facial scan occurring at step 701 authenticates the user as an authorized user of the electronic device. In one or more embodiments, decision 704 comprises comparing the facial scan to one or more predefined facial depth maps stored in memory to determine whether the facial scan sufficiently corresponds to the one or more predefined facial maps. “Sufficiently” means within a predefined threshold. For example, if one of the predefined facial maps includes 500 reference features, such as facial shape, nose shape, eye color, background image, hair color, skin color, and so forth, the facials can will sufficiently correspond to at least one of the one or more predefined facial maps when a certain number of features in the facial scan are also present in the predefined facial maps. This number can be set to correspond to the level of security desired. Some users may want ninety percent of the reference features to match, while other users will be content if only eighty percent of the reference features match, and so forth.

If there is no match, the method ends at step 705. However, where the authentication input authenticates the authorized user of the electronic device at decision 704, step 706 comprises launching, with one or more processors, at least a second authenticator.

At optional step 707, environmental conditions conducive to training the second authenticator and/or refining a predefined authentication reference can be obtained. These environmental factors can help determine, at decision 708, whether training the second authenticator and/or refining a predefined authentication reference is appropriate.

In one embodiment an environmental noise level would be determined at step 707. At decision 708, this environmental noise level could be compared to a predefined noise threshold. The predefined noise threshold may define a sound pressure level or decibel level above which, for example, voice data would be degraded to the point where creating a predefined authentication reference would not be suitable.

In one embodiment a number of persons within a predefined environment of the electronic device, such as a radius of six feet, would be determined at step 707. At decision 708, this number of persons could be compared to a predefined number such as one person. The predefined number may define a condition at which a facial recognition process could be performed with sufficient quality.

In one embodiment, a location of the electronic device can be determined at step 707. This can be compared to a predefined set of locations, e.g., a person's home, car, workplace, at decision 708.

Where conditions are appropriate for training the second authenticator and/or refining a predefined authentication reference as determined by decision 708, the same can occur at step 709. In one embodiment, step 709 comprises training, with one or more processors, a second authenticator to authenticate the authorized user using the other input of the second type. In another embodiment, step 709 comprises revising, with the second authenticator, the predefined authentication reference with the other authentication input.

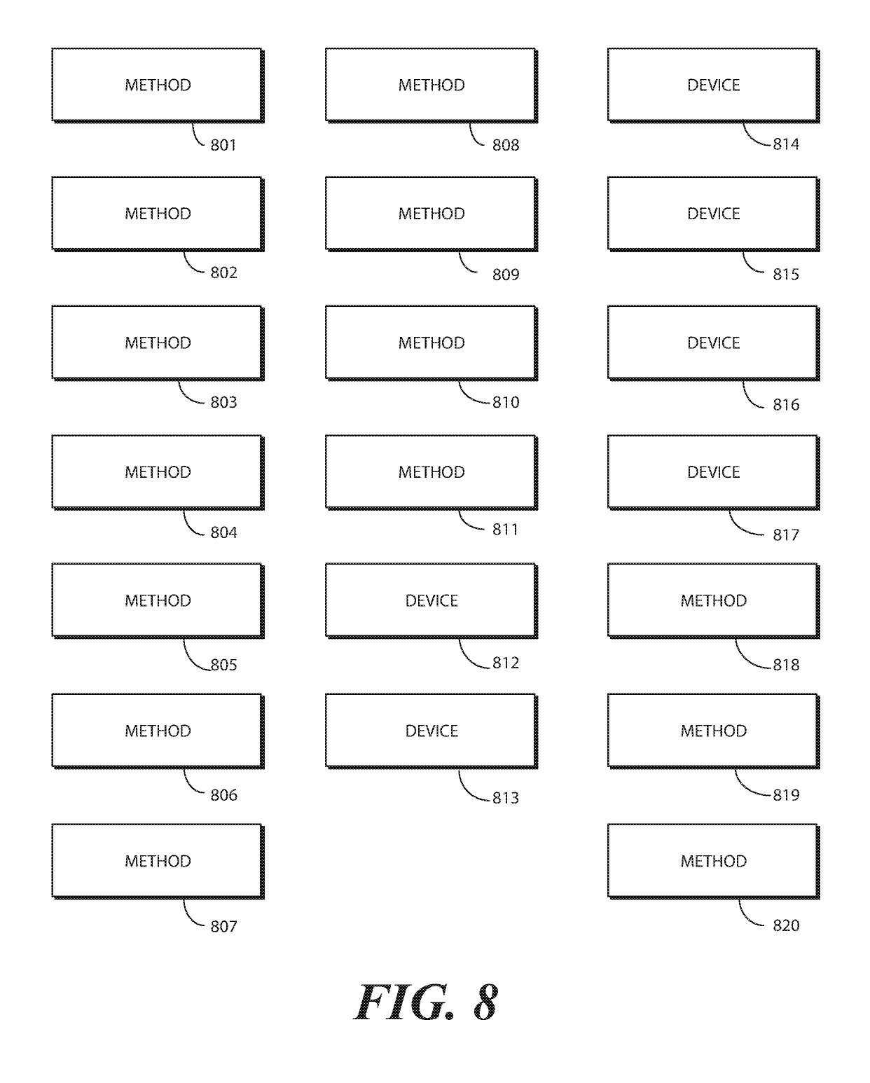

Turning now to FIG. 8, illustrated therein are various embodiments of the disclosure. At 801, a method in an electronic device comprises receiving, with one or more sensors carried by the electronic device, an authentication input of a first type, the authentication input identifying an authorized user of the electronic device. At 801, the method comprise attempting to authenticate, with a first authenticator operable with the one or more sensors, the authentication input.

At 801, the method comprises detecting, with one or more processors, reception of another input of a second type identifying the authorized user of the electronic device, wherein the second type is different from the first type. At 801, where the authentication input authenticates the authorized user of the electronic device, the method comprises launching, with the one or more processors, at least a second authenticator and processing the other input of the second type with the second authenticator.

At 802, the processing of 801 comprises storing, with the second authenticator, in a memory operable with the second authenticator, one or more digital representations of the other input of the second type as a predefined authentication reference. At 803, the method of 802 comprises receiving, with the one or more sensors, another authentication input of the second type. At 803, the method of 803 comprises attempting to authenticate, with the second authenticator, the other authentication input by comparing the other authentication input to the predefined authentication reference.

At 804, the method of 802 receiving, with the one or more sensors, another authentication input of the second type while attempting to authenticate, with the first authenticator, another authentication of the first type. At 804, the method of 802 comprises revising, with the second authenticator, the predefined authentication reference with the other authentication input.

At 805, the method of 802 further comprises determining, with the one or more sensors, whether environmental conditions match one or more predefined criteria. At 805, the method of 802 comprises precluding the storing unless the environmental conditions match the one or more predefined criteria.

At 806, the one or more predefined criteria of 805 comprise an environmental noise level falling below a predefined noise threshold. At 807, the one or more predefined criteria of 805 comprise a number of persons within a predefined environment of the electronic device being only one person. At 808, the one or more predefined criteria of 805 comprise a location of the electronic device being a predefined location selected from a predefined set of locations stored within the memory of the electronic device.

At 809, the method of 801 further comprises, prior to the launching, confirming, with the one or more sensors, that the other input of the second type originates from the authorized user of the electronic device. At 810, the confirming of 809 comprises one of detecting, with a first sensor, lip movement of the authorized user, a thermal signature of breath from the authorized user, or that audio originates within a predefined beam cone corresponding to the authorized user. At 811, the launching of 809 occurs only where the one or more sensors confirm the other input of the second type originates from the authorized user.

At 812, an electronic device comprises one or more sensors and a first authenticator, operable with the one or more sensors. At 812, the first authenticator authenticates authentication input of a first type.

At 812, the electronic device comprises at least a second authenticator, operable with the one or more sensors. At 812, the second authenticator authenticates authentication input of a second type. At 812, the second type is different from the first type.

At 812, one or more processors are operable with the first authenticator and the second authenticator. At 812, the one or more processors actuating the second authenticator where the first authenticator authenticates the authentication input of the first type and the one or more sensors detect the authentication input of the second type.

At 813, the electronic device of 812 further comprises a memory. At 813, the second authenticator stores a data representation of the authentication input of the second type in the memory.

At 814, the second authenticator of 812 attempts to authenticate another authentication input of the second type by comparing it to the data representation. At 815, the electronic device of 812 further comprises a memory storing a data representation of the second type. At 815, the second authenticator modifies the data representation of the second type with the authentication input of the second type.

At 816, upon receiving another authentication input of the first type and another authentication input of the second type, the first authenticator of 812 attempts to authenticate the other authentication input of the first type. At 816, the second authenticator of 812 attempts to authenticate the other authentication input of the second type. At 816, the one or more processors allow access to the electronic device only where the first authenticator authenticates the another authentication input of the first type and the second authenticator authenticates the another authentication input of the second type. At 817, the first authenticator of 812 comprises one of a facial imager, an iris imager, or a fingerprint sensor, while the second authenticator of 812 comprises one of a voice interface engine or a touch-sensitive user interface.

At 818 a method comprises receiving, with one or more sensors carried by an electronic device, an authentication input of a first type identifying an authorized user of the electronic device. At 818, the method comprises attempting to authenticate, with a first authenticator operable with the one or more sensors, the authentication input. At 818, the method comprises receiving, with the one or more sensors, another input of a second type identifying the authorized user of the electronic device, wherein the second type is different from the first type. At 818, the method comprises training, with one or more processors, a second authenticator to authenticate the authorized user using the other input of the second type.

At 819, the method of 818 further comprises identifying, on a user interface of the electronic device, that the training is occurring. At 820, the method of 818 further comprises receiving user input, at a user interface of the electronic device. At 820, the user input prioritizes one of the first authenticator or the second authenticator over another of the first authenticator or the second authenticator.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, with one or more sensors carried by the electronic device, an authentication input of a first type, the authentication input identifying an authorized user of the electronic device;
attempting to authenticate, with a first authenticator operable with the one or more sensors, the authentication input;
detecting, with one or more processors, reception of another input of a second type identifying the authorized user of the electronic device, wherein the second type is different from the first type; and
where the authentication input authenticates the authorized user of the electronic device, launching, with the one or more processors, at least a second authenticator; and
processing the another input of the second type with the second authenticator.

2. The method of claim 1, wherein the processing comprises storing, with the second authenticator, in a memory operable with the second authenticator, one or more digital representations of the another input of the second type as a predefined authentication reference.

3. The method of claim 2, further comprising:
receiving, with the one or more sensors, another authentication input of the second type; and
attempting to authenticate, with the second authenticator, the another authentication input by comparing the another authentication input to the predefined authentication reference.

4. The method of claim 2, further comprising:
receiving, with the one or more sensors, another authentication input of the second type while attempting to authenticate, with the first authenticator, another authentication of the first type; and
revising, with the second authenticator, the predefined authentication reference with the another authentication input.

5. The method of claim 2, further comprising:
determining, with the one or more sensors, whether environmental conditions match one or more predefined criteria; and
precluding the storing unless the environmental conditions match the one or more predefined criteria.

6. The method of claim 5, wherein the one or more predefined criteria comprise an environmental noise level falling below a predefined noise threshold.

7. The method of claim 5, wherein the one or more predefined criteria comprise a number of persons within a predefined environment of the electronic device being only one person.

8. The method of claim 5, wherein the one or more predefined criteria comprise a location of the electronic device being a predefined location selected from a predefined set of locations stored within the memory of the electronic device.

9. The method of claim 1, further comprising, prior to the launching, confirming, with the one or more sensors, that the another input of the second type originates from the authorized user of the electronic device.

10. The method of claim 9, wherein the confirming comprises one of detecting, with a first sensor, lip movement of the authorized user, a thermal signature of breath from the authorized user, or that audio originates within a predefined beam cone corresponding to the authorized user.

11. The method of claim 9, wherein the launching occurs only where the one or more sensors confirm the another input of the second type originates from the authorized user.

12. An electronic device, comprising:
one or more sensors;
a first authenticator, operable with the one or more sensors, the first authenticator authenticating authentication input of a first type;
at least a second authenticator, operable with the one or more sensors, the second authenticator authenticating authentication input of a second type, wherein the second type is different from the first type; and
one or more processors, operable with the first authenticator and the second authenticator;
the one or more processors actuating the second authenticator where:
the first authenticator authenticates the authentication input of the first type; and
the one or more sensors detect the authentication input of the second type.

13. The electronic device of claim 12, further comprising a memory, the second authenticator storing a data representation of the authentication input of the second type in the memory.

14. The electronic device of claim 13, the second authenticator attempting to authenticate another authentication input of the second type by comparing it to the data representation.

15. The electronic device of claim 12, further comprising a memory storing a data representation of the second type, the second authenticator modifying the data representation of the second type with the authentication input of the second type.

16. The electronic device of claim 12, wherein upon receiving another authentication input of the first type and another authentication input of the second type:
the first authenticator attempting to authenticate the another authentication input of the first type;
the second authenticator attempting to authenticate the another authentication input of the second type; and
the one or more processors allowing access to the electronic device only where the first authenticator authenticates the another authentication input of the first type and the second authenticator authenticates the another authentication input of the second type.

17. The electronic device of claim 12, wherein the first authenticator comprises one of a facial imager, an iris imager, or a fingerprint sensor, wherein the second authenticator comprises one of a voice interface engine or a touch-sensitive user interface.

18. A method, comprising:
receiving, with one or more sensors carried by an electronic device, an authentication input of a first type identifying an authorized user of the electronic device;
attempting to authenticate, with a first authenticator operable with the one or more sensors, the authentication input;
receiving, with the one or more sensors, another input of a second type identifying the authorized user of the electronic device, wherein the second type is different from the first type; and
training, with one or more processors, a second authenticator to authenticate the authorized user using the another input of the second type.

19. The method of claim 18, further comprising identifying, on a user interface of the electronic device, that the training is occurring.

20. The method of claim 18, further comprising receiving user input, at a user interface of the electronic device, the user input prioritizing one of the first authenticator or the second authenticator over another of the first authenticator or the second authenticator.
